(19) United States
(12) Patent Application Publication
(10) Pub. No.: US 2003/0075600 A1
(43) Pub. Date: Apr. 24, 2003

(54) Fuel dispenser having a guided customer transaction interface and the method therefor

(75) Inventors: Kevin D. Struthers, Clayton, NC (US); Michael C. Webb, Raleigh, NC (US)

Correspondence Address: DRINKER BIDDLE & REATH, ONE LOGAN SQUARE, 18TH AND CHERRY STREETS, PHILADELPHIA, PA, 19103-6996, US

(73) Assignee: Environ Products, Inc., Smithfield, NC (US)

(21) Appl. No.: 10/259,578

(22) Filed: Sep. 30, 2002

Related U.S. Application Data
(60) Provisional application No. 60/325,518, filed on Sep. 28, 2001.

(51) Int. Cl. G06F 7/08

(52) U.S. Cl. 235/381

(57) ABSTRACT

Provided is a computer-implemented, interface method by which a customer may execute transactions at a fuel dispenser having a large display and acting as a thin client in communication with at least one server. The interface is guided in that the dispenser display presents to the customer a predetermined sequence of screens, which are predetermined arrangements of objects representative of transaction opportunities. Both the arrangement of objects into screens and the sequence of screen display are reconfigurable by a fuel or retail marketer either locally or remotely from at least one host server. Also provided is a fuel dispenser having a large display and acting as a thin client in communication with at least one host server, which comprises and uses the present interface method to effect customer transactions.

### CROSS REFERENCE TO RELATED APPLICATION

This application claims the benefit of U.S. Provisional Application No. 60/325,518 filed Sep. 28, 2001.

### OVERVIEW

The invention relates generally to a fuel dispenser interface and, in particular, to a guided customer transaction interface, which presents to a customer transaction opportunities in a predetermined yet reconfigurable sequence.

Since their widespread introduction in the early 1900's, fuel dispensers have incorporated added apparatus for facilitating fuel purchases and identifying sales data. First introduced with no displays or volume indicators, fuel dispensers later featured glass container volume indicators, and still later, mechanical wheel volume and dollar sale indicators.

Currently, fuel dispensers incorporate electronic displays, such as LED or LCD purchase indicators, as well as mechanical selection buttons and other apparatus, such as credit/debit card readers, receipt printers, intercoms, and RFID scanners. Since fuel dispensers are now typically situated in a fueling and retail environment, which can include a convenience store, fast food restaurants, a car wash, and other retail establishments, these added devices facilitate the use of the fuel dispenser as the purchase site not only of fuel but other goods and services.

Current fuel dispensers display three typical configurations of mechanical buttons and/or electronic displays, by which a customer can effect a transaction at the fuel dispenser. FIG. 1 shows the first fuel dispenser display configuration, which is for “Pay Inside” transactions and has no capability for effecting payment at the dispenser. As FIG. 1 shows, a typical “Pay Inside” display configuration often includes text mechanical gas-selection buttons 900, mechanical intercom activation buttons (not shown), and small electronic display windows 904, such as liquid crystal display (LCD), light emitting diode (LED) or a vacuum fluorescent (VFD) screens, which indicate fuel volume, dollar sale amounts and unit price per gallon. Small displays generally have a diagonal of about less than four inches (10 cm).

FIG. 2 shows a typical fuel dispenser display configuration in a “Payment Terminal System” offering a menu of payment location options, which are indicated by mechanical buttons 920, such as “pay-outside”, “pay inside”, and other services such as “car wash” (not shown). This configuration often includes the mechanical selection buttons 900 and small electronic display windows 904 of FIG. 1 plus a mechanical, numbered key pad 906 for pin number entry for an associated card reader 908. Also included may be an LCD text display 922, which instructs the customer in how to begin the purchase.

FIG. 3 shows another type of “Payment Terminal System” configuration, which differs from that of FIG. 2 in that a small electronic display window 940 replaces labelled selection buttons 920. Accompanying this display are unlabeled selection buttons 942 which the customer presses to select a mode of payment.

The display configurations in FIGS. 1, 2 and 3 have limited marketing potential. They cannot present the customer a wide array of transaction opportunities, which can be ordered and executed from the site of the fuel dispenser. Such transaction opportunities include not only the purchase of gasoline, but also other goods available from the retail environment as well as special offers, loyal customer benefits, incentive programs, etc. Nor can these display configurations effectively accomplish targeted marketing or create purchase incentives. Mechanical buttons and small electronic displays convey minimal information. Current dispensers do not and cannot present customers a sophisticated marketing effort in terms of offering the panoply of goods and services available at the retail environment or other opportunities that build customer loyalty or develop brands recognition.

Display configurations of typical fuel dispensers also lack marketing efficiency because the configurations differ from one fueling station to the next and the method for using the dispenser as a purchase site are bewilderingly varied. Most dispensers feature mechanical buttons, which fade, degrade and mechanically fail. Moreover, each style of dispenser has a different set of buttons and display windows with different protocols, prompts for customer information and sequencing of input requests. Presently, for each new experience of purchasing gasoline, a customer has to re-learn the use of the fuel dispenser's display configuration as well as any software interface. For example, at one service station a customer can simply remove the nozzle and beginning fueling. At a second station, the customer removes the nozzle and presses a button before fueling. At a third station, customers press a button before inserting a credit or debit card into the dispenser's card reader and at still others, the customer's card is immediately insertable.

To successfully obviate the limitations in current customer interface methods used at fuel dispensers as a purchase site, the present invention provides a computer-implemented customer transaction interface which comprises method for guiding customer transactions at a fuel dispenser. The present invention also provides a fuel dispenser utilizing the interface method.

### SUMMARY OF THE INVENTION

The present fuel dispenser is in communication with at least one host server and thereby operates as a programmable thin client. It has a large graphics display and a magnetic card reader. A large display has about at least a twelve-inch (30 cm) diagonal. The fuel dispenser may also have a receipt printer. Relying on the large display of the present fuel dispenser, the present interface method displays to a customer selectable objects, such as a graphic, video, icon, animation, text and so forth, which represent transaction opportunities. Transaction opportunities include not only offers to purchase but also offers to get cash, play a game, participate in a promotion, etc. The display may allow touch-activated selection of transaction opportunities. The present dispenser may also comprise an intercom system and a microphone by which sight-impaired customers can use the guided interface method.

The present method provides a computer-implemented, guided customer transaction interface by which a customer may execute transactions at a fuel dispenser. The interface is guided in that the dispenser display presents the customer a predetermined arrangement of objects, which represent transaction opportunities, in a predetermined, logical sequence that depends on the customer's responses to previously-displayed menus. The present method also provides that both the arrangement of objects into screens and the logical sequence of screen presentation are reconfigurable by a fuel or retail marketer either locally or remotely from at least one host server.

The present method of the transaction interface effects transactions at the site of the fuel dispenser and is used in a fuel dispenser that communicates with at least one host server and which operates as a thin client for the host server(s). The method is utilized by displaying on the fuel dispenser's display selectable objects which represent transaction opportunities. The objects comprise at least one mathematical and/or logical term and at least one property. The method comprises the steps of:

a) configuring the terms and properties of the objects into a plurality of screens, each screen displaying a distinctive arrangement of selectable objects;

b) configuring a sequence for displaying the plurality of screens;

c) displaying a first screen to a customer;

d) the customer selecting at least one displayed object;

e) in response to the customer's selection, displaying at least one subsequent screen;

f) repeating steps (d) and (e) until all desired transaction opportunities have been chosen;

g) at any point in the method after step (b), reconfiguring from the at least one host server at least one term or at least one property of at least one of the displayed objects as well as reconfiguring the sequence of display of at least one screen.

Another embodiment of the present method may add the following steps:

h) the customer inputting requested identification data;

i) transmitting signals representative of the requested identification data to the host server;

j) in response to the transmitted signals, reconfiguring from the at least one host server at least one property of at least one of the displayed objects;

k) in accordance with the at least one reconfigured property, displaying at least one subsequent screen.

To accommodate those customers who may be visually impaired or unable to respond to the display by touch, the fuel dispenser may further comprise means for communicating by sound the queries of the transaction interface and a voice-activated means for inputting customer selections in response to those queries. When such apparatus is used, an embodiment of the present method comprises in addition to the above the steps of:

a) aurally communicating a first set of selectable objects;

b) the customer selecting at least one aurally communicated object;

c) in response to the customer's selection, aurally communicating subsequent screen of selectable objects;

d) repeating steps (b) and (c) until all desired transaction opportunities have been chosen.

The present invention also provides a fuel dispenser, which is in communication with at least one host server and which operates as a programmable thin client for displaying selectable objects representative of transaction opportunities, the dispenser comprising:

means for dispensing fuel,

means for displaying objects,

means for accepting payment from a customer, and

a guided customer transaction interface,

wherein the guided customer transaction interface comprises the method of the present invention.

### BRIEF DESCRIPTION OF THE DRAWINGS

FIG. 1 illustrates a prior art “Pay Inside” display configuration of a fuel dispenser, showing mechanical buttons and small display windows.

FIG. 2 illustrates a prior art “Payment Terminal System” display configuration of a fuel dispenser, showing mechanical buttons, small display windows and payment apparatus for paying at the fuel dispenser.

FIG. 3 illustrates another embodiment of a FIG. 2 configuration.

FIG. 4 illustrates an embodiment of a screen sequence of the present interface method.

FIG. 5 illustrates another embodiment of a screen sequence of the present interface method, displayed during fueling.

FIG. 6 is a flow chart illustrating one embodiment of present interface method.

### DETAILED DESCRIPTION

In the following description, like reference characters designate like or corresponding parts or steps throughout the several figures. The illustrations are for the purpose of describing embodiments of the invention and are not intended to limit the invention thereto.

A fueling and retail environment may include a fueling station having one or more fuel dispensers, a convenience store, at least one fast food restaurant and at least one car wash. Such an environment provides customers multiple transaction opportunities, including the purchase of fuel, goods and services relating to their vehicle the purchase of fast food and all manner of goods available at a convenience store.

The present invention provides a computer-implemented method for guiding customer transactions at a fuel dispenser and the fuel dispenser utilizing these in communication with at least one host server. The fuel dispenser of the present invention operates as a thin client in communication with at least one host server. In client/server applications, a thin client is a network computer without a hard disk drive so that the bulk of data processing occurs on the server(s). The communication between a fuel dispenser and the host server(s) can be any computer-implemented network, including LAN, WAN, SAN, Internet-Protocol based, intranet, extranet, wireless and other configurations known to those skilled in the art. The one host server(s) may be physically located at the local retail environment and/or remotely located. Although the computer-implemented network is generally described here as having a client/server architecture, the method of the present invention may also be practised using peer-to-peer architecture.

The fuel dispenser of the present invention comprises means for dispensing fuel, means for displaying objects, means for accepting payment from a customer, and the guided transaction interface method of the present invention. The means for dispensing fuel include the conventional means known to those skilled in the art as well as modular metering cartridge and modular magnetic pulsars. The display means of the present dispenser are preferably large, that is, having a diagonal of about at least twelve inches (30 cm), and may include a touch screen over an LCD display, a touch-activated LCD display, a stylus-activated LCD display and/or a verbal response, i.e., a voice-activated LCD display, as well as other forms of large display means known to those skilled in the art. Moreover, the dispensers of the present invention may be equipped with built-in stereo speakers and microphones for providing music, audio advertisements or intercom communications between the retail store attendant and the fueling customer.

The present dispenser may also comprise small, removable plug-in circuit cards. In addition, many of the dispenser's components may be modular, that is, comprise an independently operable unit. Such modular components may include receipt printers, card readers, solenoid valves, LCD displays, and touch screens.

The present method functions as a graphical user interface through which a customer is presented and executes at the fuel dispenser transaction opportunities. These opportunities may be presented and executed through a touch-activated, large display, i..e., a display having a screen of about a twelve-inch (30 cm) diagonal. Another embodiment of the method presents and executes the transaction opportunities through an intercom and voice-activated means, such as a microphone and/or voice-activated LCD display. In addition to transaction opportunities, the present method may present advertising promotions and special offers as well as allow the customer to request and display more detailed merchandising information about offered specials.

The interface method comprises configuring the terms and properties of the presented objects into a plurality of screens. Each screen displays a distinctive arrangement of selectable objects. Initially configured by the dispenser manufacturer, the interface may be reconfigured by fuel and retail marketers and, even to some extent, by the fueling customer. The ability of the interface to be reconfigured provides to fuel and retail marketers great flexibility to tailor the content of the screens and the sequence of their presentation to capitalize on the purchasing habits of diverse segments of the consumer population. Specifically, reconfigurability of the interface allows instantaneous price point changes; customized language options; daily promotions, such as morning, afternoon or evening specials; customer specific marketing, such as lottery promotions for frequent lottery players; service and merchandise promotions, such as for new products and brand promotions; and customer loyalty programs, such as repeat customer incentives, sweepstakes and games.

Because the fuel dispenser acts as a thin client and is in communication with at least one host server, the present method provides the opportunity for several fuel and/or retail marketers to reconfigure the transaction interface separately and independently. Take, for example, a retail environment at which Texaco gasoline is sold and which includes a McDonald's restaurant. The present method allows the transaction interface to be reconfigured by the on-site Texaco fuel marketer, which may change the gasoline price point on its fuel dispenser's display through the connection between its server and the dispenser. The marketing division at Texaco corporation may independently reconfigure the interface remotely at certain times of the year to display seasonal promotions for example, on motor oil. Further, the McDonald's corporation may also reconfigure the interface remotely to display on the dispenser's screens promotions for McDonald's food items available at the local retail environment.

In object-oriented programming, an object is a self-contained entity that can be individually selected and manipulated. It may be either data or a procedure to manipulate data. Objects can include shapes and pictures that appear on a display as well as less tangible software entities, such as queries, or requests, for information either from a database or from the customer directly. The terms of an object are the equations, instructions (commands), and/or input data that accomplish a specific task, such as selecting a grade of fuel, recording payment from a debit card, identifying a food choice, etc. The property of an object is generally an appearance characteristic, that varies, such as its size on the display screen, its location, border, shape, text color, text style, background color and so forth.

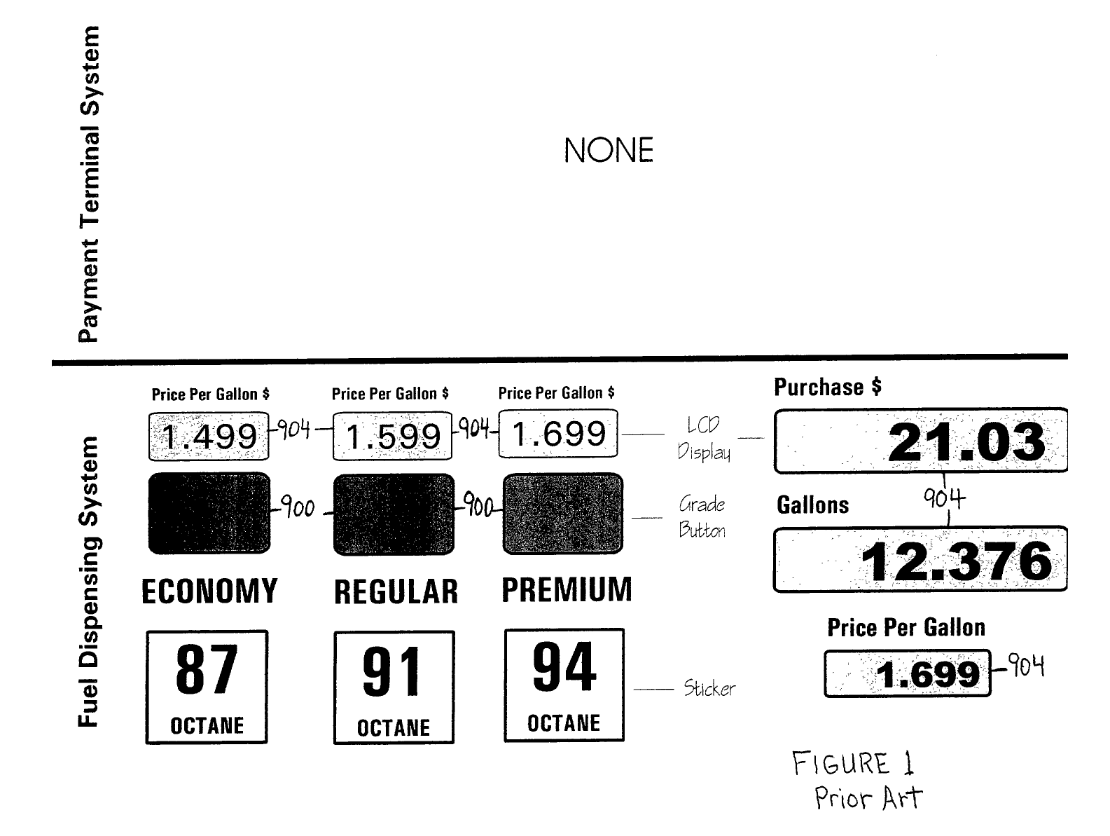

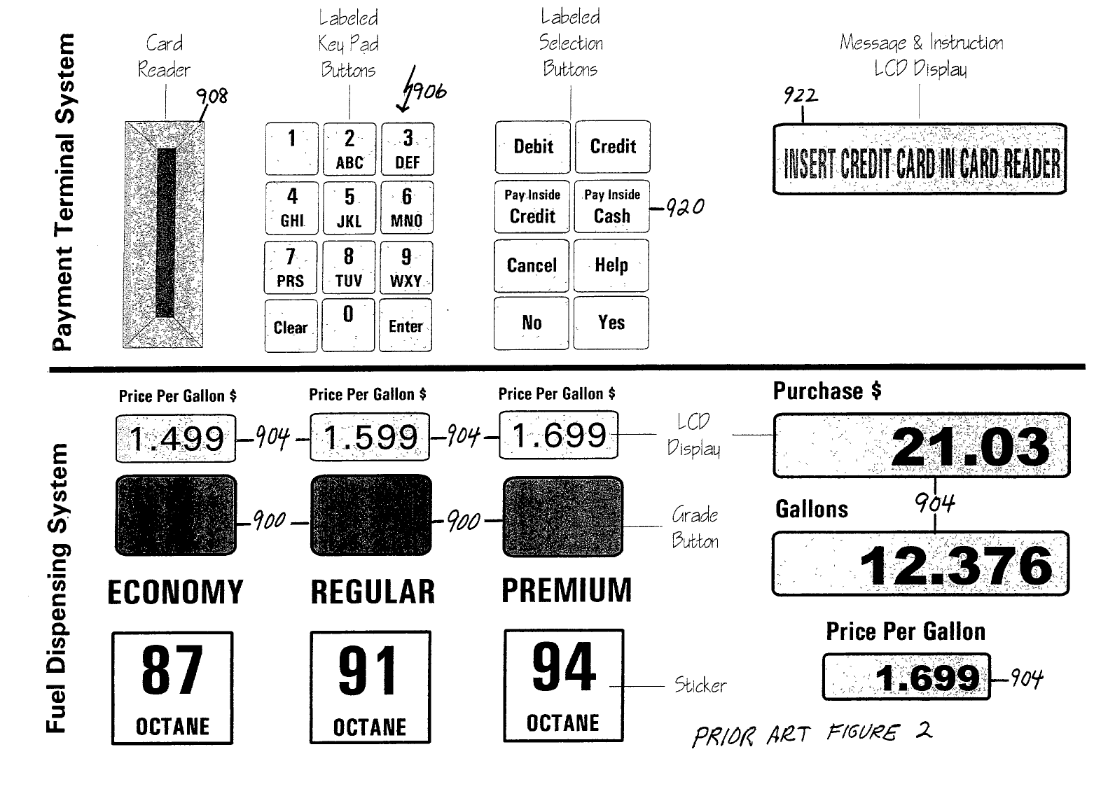

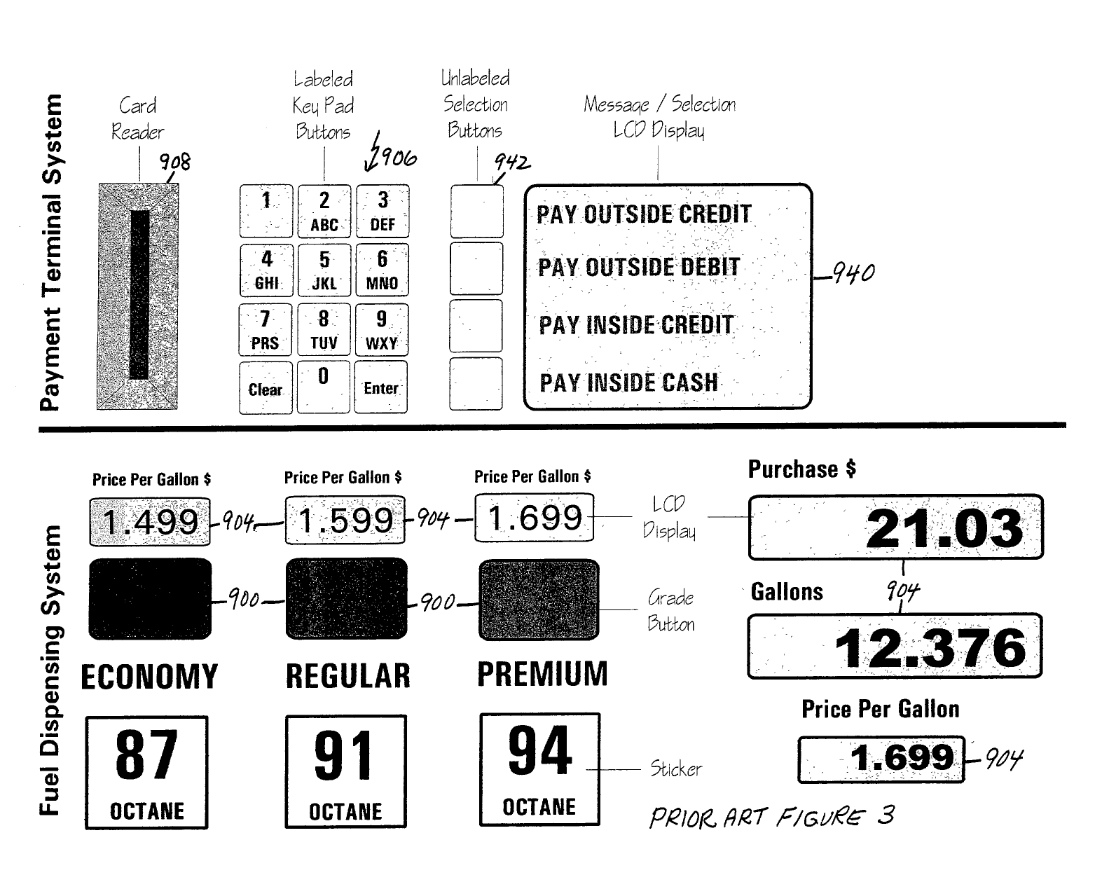

The present method is used with large, integrated displays such that all of the selectable objects for carrying out a query or a transaction may appear on a single display. Selectable objects in the present method include button objects, text objects, indicator objects and graphic objects. These objects replace the interface controls found on conventional display configurations, such as in FIGS. 1, 2 or 3. For example, button objects replace mechanical push buttons; indicator objects replace small LED display windows; text objects replace labels or stickers; and graphic objects replace ad banners and signage.

Although certain objects can be configured only by the dispenser manufacturer, many objects may be reconfigured locally or remotely by a fuel or retail marketer and, to some extent, by the customer. Reconfiguration of the objects may occur during the execution of a transaction or between transactions or at regularly scheduled periods. Reconfiguration of the terms and properties of the objects changes the distinctive appearance of the screens as well as the sequence in which the screens are displayed. Allowing a retailer whose server is in communication with the fuel dispenser to reconfigure at will the terms and properties of the interface objects accommodates the retailer's need to display special offers and/or marketing information.

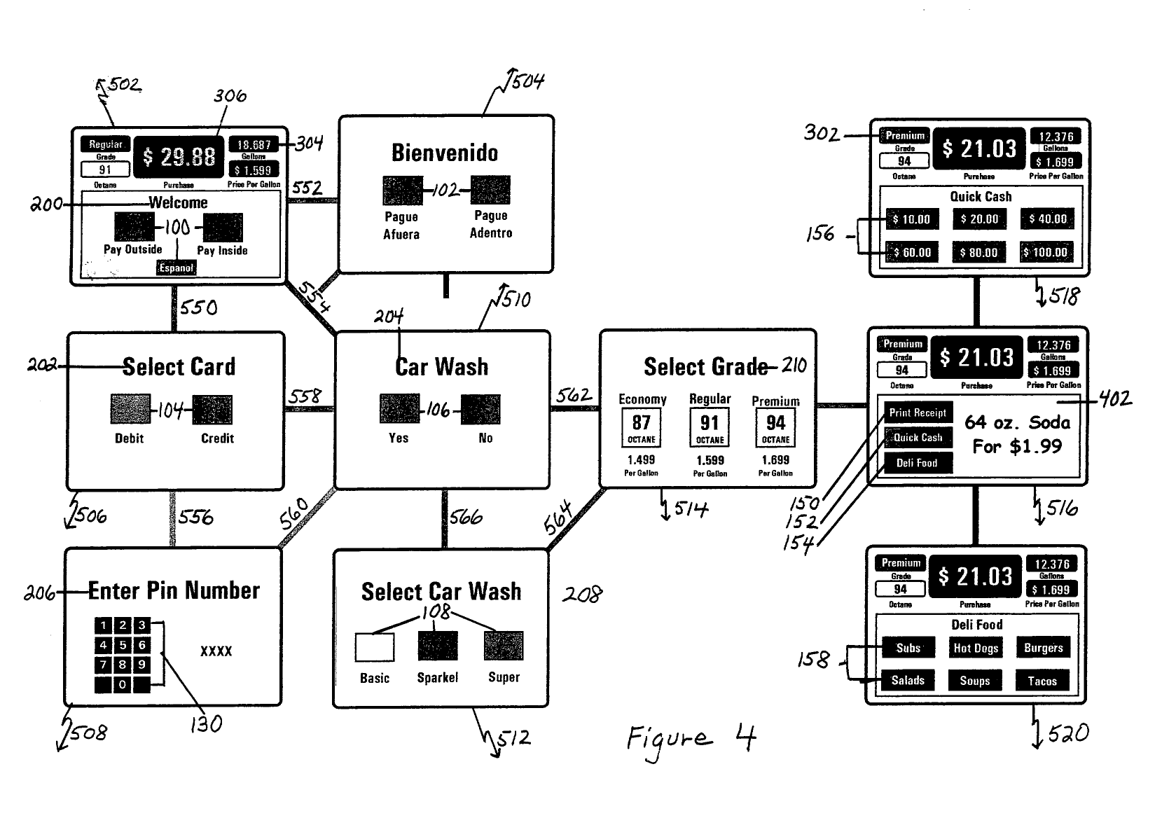

In FIG. 4, examples of button objects are elements 100, 102, 104, 106 and 108 plus 150-158. The fuel or retail marketer can reconfigure both the terms and properties of button objects. The terms of an object can be the logical and/or mathematical relationships that connect objects to each other and cause them to be displayed together within the same screen or in subsequent screens or in alternative screens. Thus, reconfiguring the terms of objects can change which objects will appear together in the same screen and may directly change the distinctive arrangement of objects into individual screens. Further, reconfiguring the terms of objects can also change the sequence of displayed screens. Ultimately, reconfiguring the objects changes the way transaction opportunities are displayed to the customer and the order in which they are displayed. The properties of button objects include the button's size, appearance, location, color, text, sounds and shape.

Examples of text objects in FIG. 4 include elements 200, 202, 204, 206, 208 and 210. The fuel or retail marketer may change only the properties of text objects, their appearance attributes such as size, font, color and background color.

In FIG. 4, examples of indicator objects are elements 300, 302 and 304. Both terms and properties of these objects are reconfigurable by the fuel or retail marketer. Indicator objects identify measurable or calculable quantities and include currency in dollars, marks, franks, etc.; unit volumes in gallons, liters, etc.; dates in M/D/Y or D/M/Y formats; time in AM/PM or 24-hour formats; temperature in Fahrenheit or centigrade degrees, etc. The properties include the indicator size, location, border, shape, text color, text style and background color.

Graphic objects, such as element 402 in FIG. 4, include displayable illustrations, photographs, videos, or stylized text, which the fuel or retail marketer may order from a cable or satellite programming provider, obtain from a web site through an internet connection or from a telephone service provider or provide locally, such as by downloading onto the dispenser a CD of digital photographs. The inclusion of graphic objects on the large display allows the fuel or retail marketer to show film clips, movies, animated shorts, video advertisements, sports events, photographs and other visual material to enhance its marketing and promotions. The fuel or retail marketer may reconfigure both the terms and the properties of graphic objects. The terms of graphic include communication connections, such as to web sites, cable and satellite programming providers and telephone service providers, for ordering downloadable visual and audio content. The properties of these objects include their size, location, border shapes (frames or skins), logos, text color, text style, background color, and static or motion graphics.

Compared with that of the fuel or retail marketer, the customer also has a more limited ability to reconfigure the properties of various objects in the interface. In particular, those reconfigured by the customer are objects automatically modified upon the input of customer identification information such as by inserting a credit or debit card, through voice recognition, finger swipe, key tag, etc. In this way, the interface may be personalized for an individual customer. Such reconfigured properties may include a tailored customer greeting in a text object, e.g. “Welcome Roberta S. Simmons to GasMart”. Also included may be an individualized loyalty purchases report in a graphics object, e.g. “Since Jun. 1, 2001, Ms. Simmons, you have made $124.65 of purchases at GasMart and have earned 623 bonus points” or “you have saved $75.00”.

In addition, the present interface used in a fuel dispenser as a thin client in communication with a host server(s) allows a retail marketer to use customer preferences or sales history obtained from a professional marketing database to target an individual customer for certain merchandise promotions. For example, when a particular customer keys in her identification data, the marketing database on a connected host server may be queried. In response to an indication from the database indicating that the customer likes chocolate, the host server in communication with the fuel dispenser can immediately reconfigure the local dispenser interface in order to display a graphic object, such as a candy bar advertisement, photographs of candy bars, candy manufacturer's logo, or play the candy manufacturer's jingle, etc.

Pre-Fueling Display Screen Sequence

FIG. 4 shows an embodiment of a screen sequence of the guided customer interface of the present invention. When a customer first arrives at the fuel dispenser, a Welcome screen 502 is displayed. Generally, the customer will be presented with a few queries before the fueling process starts. These queries may include preferred language, method of payment, a key pad for account number entry, and whether a car wash is desired.

The screen sequence will change depending on which objects the customer selects. If the button object 100 for Espanol is pressed, the sequence proceeds to screen 504, which displays text objects 102 in Spanish. After a preferred location of payment is selected, the screen sequence proceeds to a query in screen 506 about mode of payment. Next in the sequence, screen 508 facilitates the input of a customer's payment identification data using composite button object 130, which displays as a numeric keypad.

Screen 510 displays a transaction opportunity for a car wash in the form of a query using button objects 106. As indicated by path 554, FIG. 4 intends to show that the car wash transaction opportunity in screens 510 and 512 does not necessarily display after the payment options. Rather, several embodiments of screen sequences related to language choice, payment mode and a car wash are possible. For example, one embodiment of a screen sequence may be to display the Welcome Screen 502 first, the Language Choice screen 504 next, followed by the Mode of Payment screens 506 and 508, and lastly Car Wash screens 510 and 512.

As paths 550, 552 and 554 indicate, another embodiment of a screen sequence may be to display first the Welcome Screen 502, next Language Selection screen 504, followed by the Car Wash Screen 510 and then 512. This sequence may be employed when the customer opts to pay inside. In any event, all screen sequences begin with Welcome Screen 502 and may vary after that.

Instead of offering a car wash as the first transaction opportunity, a fuel or retail marketer may reconfigure the screen sequence so that the first transaction opportunity is an order for food, purchase of a video, etc., depending on the retail environment. As previously discussed, by reconfiguring the terms of those objects to which it has access, a retail and fuel marketer may either locally or remotely, create new screens as distinctive arrangements of objects as well as alter the sequence of screen display.

In the discussion above, it was pointed out that the fuel or retail marketer, in response to entry of a customer's identification data into the network, may almost instantaneously reconfigure screen content and screen sequence based on downloaded, individualized marketing data. The present method is not limited to being reconfigured relative to input of customer data, but has a much wider capability. Specifically, the method may be configured at almost any time, whether during a transaction, or between transactions, or on a regularly scheduled basis, or at will by a local or remote fuel/ retail marketer.

Fueling Display Screen Sequence

The screen sequence then proceeds to the Select Grade screen 514, at which point the customer chooses a fuel grade and fueling begins. It is especially during fueling that the present interface method demonstrates its flexibility. That is, during fueling, the screen sequence may display an almost limitless variety of transaction opportunities depending both on the initial screen sequence configured by the fuel merchandiser and on subsequent reconfiguring of the screen sequence primarily by a fuel or retail marketer and to a lesser extent by the customer.

In particular, during fueling, the present method demonstrates features not present in current dispenser interface methods. Since the fuel dispenser is a thin client and in communication with at least one host server, thereby creating a network, the interface method may be reconfigured during fueling either locally at the level of the gas station or convenience store or remotely. Reconfigurability would allow the marketing headquarters for, say, Amoco or Exxon-Mobil, to customize the screens and screen sequence for a certain marketing milieu and set of customer demographics.

The screen sequence proceeds to screen 516, which comprises button objects 150 - 154 and graphics object 402. Print Receipt button object 150 is a query. Quick Cash button object 152 is a transaction opportunity that allows the customer to use the fuel dispenser as an ordering point to request cash from an ATM within the retail environment, such as within the convenience store, or from the fuel dispenser directly, when it is so adapted to serve as an ATM. The Deli Food button object 154 offers the customer a transaction opportunity to purchase food from an associated fast food restaurant or convenience store within the retail environment.

If the Quick Cash button object 152 is selected, Quick Cash screen 518 displays and offers to the customer in buttons 156 discrete amounts of cash from the ATM service point. If the Deli Food button object 154 is selected, Deli Food screen 520 displays and offers the customer various food purchases as shown in button objects 158.

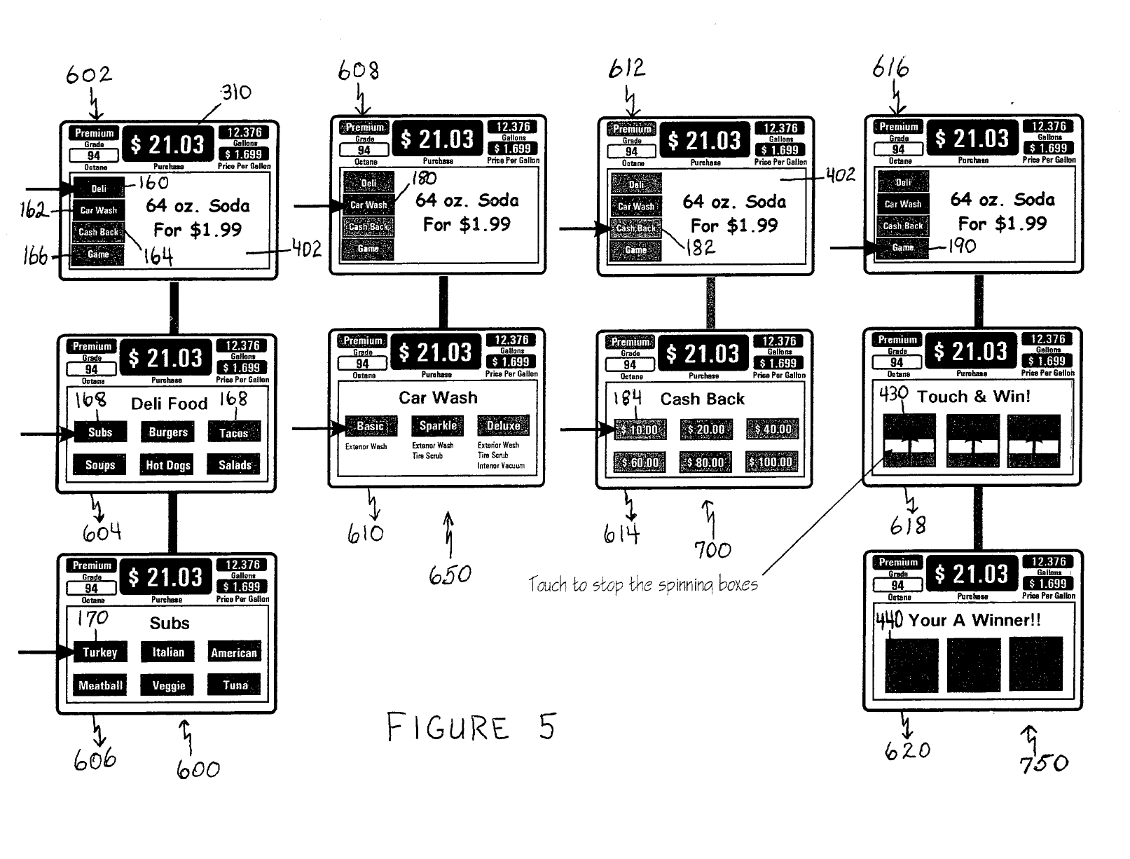

In FIG. 4, the combination of screens 516, 518 and 520 exemplifies but one embodiment of a screen sequence and but one embodiment of arranging objects into distinctive screens. The variety in composing distinctive screens from button, text, indicator and graphics objects is virtually unlimited and depends on the kinds of transaction opportunities, queries and marketing efforts the retailer directs to the customer. The present method is not intended to be limited to the specific screens, that is, the specific arrangement of objects, shown in FIGS. 4 and 5. Nor is it intended that the present method be limited to the specific screen sequences exemplified in FIGS. 4 and 5.

In addition to the embodiments shown in FIG. 4, FIG. 5 demonstrates that a wide variety of screen sequences may be displayed to the customer during fueling, as exemplified in screen sequences 600, 650, 700 and 750. Each of these sequences proceeds from screen 602, which shows the amount of the customer's fuel purchase in indicator object 310 and offers a promotion on a convenience store item, e.g., a 64-ounce bottle of soda, in graphic object 402. Screen 602 also displays four transaction opportunities: Deli button object 160, Car Wash button object 162, Cash Back button object 164, and Game button object 166. The pointing arrows indicate the customer's selections in the screen sequences of FIG. 5.

Screen sequence 600 relates to a transaction opportunity for purchasing food items from an associated convenience store. Screen 602 shows the Deli button object 160 selected. Screen 604 shows the food choices in button objects 168. Screen 608 shows the customer's food selection at button object 170.

Another embodiment of a car wash opportunity is shown in screen sequence 650 in which a customer selects a car wash in screen 608 and specifies it as basic in screen 610. Screen sequence 700 is another embodiment of a sequence in which the customer can use the fuel dispenser as an ATM ordering point. In screen 612, the customer selects Cash Back button object 182 and in screen 614, identifies the cash amount to be received in button object 184.

Screen sequence 750 relates to a customer's selection of a fuel or retail marketer's special promotion. Screen 618 shows one embodiment of a special promotion in the form of a customer loyalty program presented as a game. Upon selecting Game 190 in screen 618, the customer is presented Spinning Box graphic object 430, which displays as a visual slot machine in which, for example, boxes of different colors are spinning. When the customer touches the Spinning Box graphic 430 in the correct box, a text message 220 “You're a Winner” appears in screen 620. The information that the customer has “won” is communicated to the host server and allows the marketer to reward the customer in various ways known to those skilled in the art: for example, on the spot with a free tank of gasoline, or at a later date with a reduced price of gasoline or by having the customer accumulate “wins”, which may be “cashed in” later for a larger reward, and so forth.

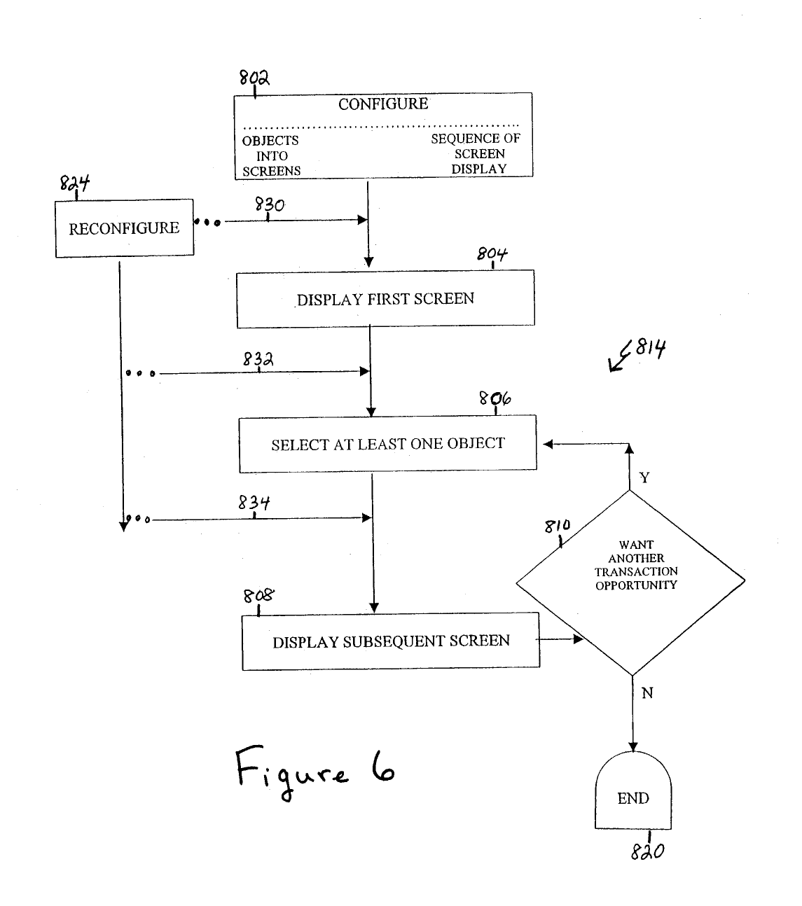

FIG. 6 shows one embodiment of the present interface method. A present method may begin at node 802 when the fuel dispenser manufacturer or other entity, such as an OEM distributor or software manufacturer, initially configures the terms and properties of the objects used in the interface method into distinctive screens and into a sequence for displaying the screens. In accordance with the interface configuration, at node 804, the present dispenser displays to a customer a first screen. At node 806, the customer selects at least one object which may represent a query or a transaction opportunity. At node 808, in response to the customer's selection, a subsequent screen is displayed, which may offer the customer another transaction opportunity or a chance to input further information. As shown in decision node 810, if the customer wishes further transaction opportunities, the method enters loop 814, in which the customer selects another object at 806 and cycles through nodes 808 and 810 until the customer stops selecting transaction opportunities. At that point, the method ends at 820.

At any point in the method after step 802 and before 820, a fuel or retail marketer may reconfigure the terms and the properties of the objects of the interface method, which will change the interface screens by displaying different transaction opportunities and queries. Also, reconfiguring may change the sequence in which the new screens are displayed. Arrows 830, 832 and 834 show broken lines to indicate that the reconfiguring may occur at any point after step 802 and before 820 and that reconfiguring may even occur several times during a single fueling experience.

Certain modifications and improvements will occur to those skilled in the art upon a reading of the foregoing description. It should be understood that all such modifications and improvements have been deleted herein for the sake of conciseness and readability. It will be readily apparent that such modifications and improvements could be made therein without departing from the scope of the invention as defined in the following claims.

1. A computer-implemented method for guiding a customer transaction at a fuel dispenser, wherein the fuel dispenser is in communication with at least one host server, comprises a card reader and a display, and operates as a programmable thin client for displaying selectable objects representative of transaction opportunities, wherein each object comprises at least one term and at least one property, the method comprising the steps of:
a) configuring the terms and the properties of the objects into a plurality of screens, each screen comprising a distinctive arrangement of selectable objects;
b) configuring a sequence for displaying the plurality of screens;
c) displaying to a customer a first screen;
d) the customer selecting at least one displayed object;
e) in response to the customer's selection, displaying at least one subsequent screen;
f) repeating steps (d) and (e) until all desired transaction opportunities have been chosen;
g) at any point in the method after step (b), reconfiguring from the at least one host server at least one term or at least one property of at least one of the displayed objects as well as the sequence of display of at least one screen.

2. The method of claim 1, further comprising the steps of:
h) the customer inputting requested identification data;
i) transmitting to the at least one host server signals representative of the requested identification data;
j) in response to the transmitted signals, reconfiguring from the at least one host server at least one property of at least one of the displayed objects;
k) in accordance with the at least one reconfigured property, displaying at least one subsequent screen.

3. The method of claim 1, wherein the fuel dispenser further comprises means for aurally communicating the selectable objects and voice-activated means for inputting customer selections of selectable objects, the method further comprising the steps of:
a) aurally communicating a first screen of selectable objects;
b) the customer selecting at least one aurally communicated object;
c) in response to the customer's selection, aurally communicating a subsequent screen of selectable objects;
d) repeating steps (b) and (c) until all desired transaction opportunities have been chosen.

4. A fuel dispenser for guiding a customer transaction, wherein the fuel dispenser is in communication with at least one host server and operates as a programmable thin client for displaying selectable objects representative of transaction opportunities, wherein each object comprises at least one term and at least one property, said dispenser comprising:
means for dispensing fuel,
means for displaying objects,
means for accepting payment from a customer, and
a guided customer transaction interface,
wherein the guided customer transaction interface comprises a method comprising the steps of:
a) configuring the terms and the properties of the objects into a plurality of screens, each screen comprising a distinctive arrangement of selectable objects;
b) configuring a sequence for displaying the plurality of screens;
c) displaying to a customer a first screen;
d) the customer selecting at least one displayed object;
e) in response to the customer's selection, displaying at least one subsequent screen;
f) repeating steps (d) and (e) until all desired transaction opportunities have been chosen;
g) at any point in the method after step (b), reconfiguring from the at least one host server at least one term or at least one property of at least one of the displayed objects as well as the sequence of display of at least one screen.

5. The fuel dispenser of claim 4, wherein the method further comprises the steps of:
h) the customer inputting requested identification data;
i) transmitting to the at least one host server signals representative of the requested identification data;
j) in response to the transmitted signals, reconfiguring from the at least one host server at least one property of at least one displayed object;
k) in accordance with the at least one reconfigured property, displaying at least one subsequent screen.

6. The fuel dispenser of claim 4, further comprising means for aurally communicating the selectable objects and voice-activated means for inputting customer selections of selectable objects, the method further comprising the steps of:
a) aurally communicating a first screen of selectable objects;
b) the customer selecting at least one aurally communicated object;
c) in response to the customer's selection, aurally communicating a subsequent screen of selectable objects;
d) repeating steps (b) and (c) until all desired transaction opportunities have been chosen.
